(19) United States
(12) Patent Application Publication
(10) Pub. No.: US 2009/0242283 A1
(43) Pub. Date: Oct. 1, 2009

(54) Touch Panel Device

(76) Inventor: Yen-Ch CHIU, Hsin-Chu (TW)

Correspondence Address: Portal IPR Office;Chun-Ming Shih, P.O. box 223205, Chantilly, VA, 20153, US

(21) Appl. No.: 12/402,456

(22) Filed: Mar. 11, 2009

(30) Foreign Application Priority Data
Mar. 25, 2008 (TW) 097110639

(51) Int. Cl. G08C 21/00

(52) U.S. Cl. 178/20.01

(57) ABSTRACT

In one exemplary embodiment, a touch panel device includes a substrate, an insulating layer, a number of first electrode groups and a number of second electrode groups. The first electrode groups are formed on the first surface of the insulating layer. Each of the first electrode groups includes a number of first electrodes and a number of first leads. The first electrodes are spaced with each other. The first leads electrically connect each two adjacent first electrodes. Each of the second electrode groups includes a number of second electrodes and a number of bridge conductors electrically connecting each two adjacent second electrodes. The second electrodes are spaced with each other and are arranged on the first surface of the insulating layer. The first electrodes and the second electrodes are arranged in a staggered manner. The bridge conductors are formed on the second surface of the insulating layer.

### CROSS-REFERENCE TO RELATED APPLICATIONS

This application is based upon and claims the benefit of priority from the prior Taiwanese Patent Application No. 097110639, filed Mar. 25, 2008, the entire contents of which are incorporated herein by reference.

### BACKGROUND

1. Field of Invention

The present invention generally relates to a touch panel device, more specifically, to a capacitive touch panel device.

2. Description of Related Art

Currently, touch panel devices are widely used in various kinds of electronic devices, for example, auto teller machines (ATM) of finance organizations, auto guide system in department store, personal digital assistant (PDA) or laptop computer. Touch panel devices can be sorted into several types according to different mechanisms of detecting touch point. Each type of touch panel device has different advantages and disadvantages.

FIG. 1 illustrates a structure of a generally used capacitive touch panel device, which includes a plain substrate 11, a first electrode unit 12 formed on a top surface of the substrate 11, a second electrode unit 13 formed on a bottom surface of the substrate 11, a first lead unit 14 extending from an edge of the top surface to a center of the top surface and electrically connecting the first electrode unit 12, a second lead unit 15 extending from an edge of the bottom surface to a center of the bottom surface and electrically connecting the second electrode unit 13, a first extending lead unit 16 and a second extending lead unit 17. The first extending lead unit 16 and the second extending lead unit 17 respectively connect the first lead unit 14 and the second lead unit 15 to a power supply or a circuit. Specifically, electric current or signals can be conducted to the first electrode unit 12 and the second electrode unit 13 via the first, second lead unit 14, 15 and the first, second extending lead unit 16, 17 thereby forming an electric field between the top surface and the bottom surface of the substrate 11. When an object (e.g. a finger of a user) touches or is near to the touch panel device, the object will slightly intervene the electric filed between the first electrode unit 12 and the second electrode unit 13, a position (i.e. coordinates) of such a touch point can be detected by detecting the capacitance change.

However, during manufacturing of above capacitive touch panel device, the first extending lead unit 16 and the second extending lead unit 17 must be respectively bonded on the top surface and the bottom surface of the substrate so as to connect the first, second lead unit 14, and electrically connect the first, second electrode unit 12, 13. In addition, when the first, second extending lead unit 16, 17 extends outside the substrate 11, a cross talk occurs due to the altering distance between the first extending lead unit 16 and the second extending lead unit 17. The cross talk will interfere with detecting of touch point thereby resulting in low yield rate.

Therefore, there is a desire to provide a touch panel device that is capable of overcoming aforementioned problems and has simplified structure and manufacturing process.

### BRIEF SUMMARY

An object of the present invention is to provide a touch panel device having simplified structure and manufacturing process.

In order to achieve above object, in one exemplary embodiment a touch panel device is provided, which includes a substrate, an insulating layer, a number of first electrode groups and a number of second electrode groups. The insulating layer is formed on the substrate and includes a first surface adjacent/adjoining to the substrate and a second surface away/spaced from the substrate. The first electrode groups are formed on the first surface of the insulating layer. Each of the first electrode groups includes a number of first electrodes and a number of first leads. The first electrodes are spaced with each other and are arranged on the first surface of the insulating layer. The first leads electrically connect each two adjacent first electrodes. Each of the second electrode groups includes a number of second electrodes and a number of bridge conductors electrically connecting each two adjacent second electrodes. The second electrodes are spaced with each other and are arranged on the first surface of the insulating layer. The first electrodes and the second electrodes are arranged in a staggered manner. The bridge conductors are formed on the second surface of the insulating layer.

In another embodiment, the substrate of the touch panel device is a transparent film. Further, the touch panel device van includes an anti-wearing layer arranged on a side of the substrata that is away from the insulating layer.

In still another exemplary embodiment, a touch panel device is also provided, which includes a substrate, an insulating layer and a capacitive sensing unit. The substrate includes a plain surface. The insulating layer is formed on the substrate. The capacitive sensing unit includes a number of first electrode groups and a number of second electrode groups covered by the insulating layer. Each of the first electrode groups includes a number of first electrodes and a number of first lead configured for electrically connecting each two adjacent first electrodes. The first electrodes are spaced with each other and are formed on the plain surface of the substrate. Each of the second electrode groups includes a number of second electrodes and a number of bridge conductors configured for electrically connecting each two adjacent second electrodes. The second electrodes are spaced with each other and are formed on the plain surface of the substrate. The first electrodes and the second electrodes cooperatively define a sensing surface. The bridge conductors are disposed on the insulating layer such that the sensing surface is arranged between the substrate and the bridge conductors.

Compared with the prior art touch panel devices, the first electrode groups and the second electrode groups are arranged on a same side of the substrate, the insulating layer serves as an electrically isolating medium of the first electrode groups and the second electrode groups, the first electrodes are electrically connected by the bridge conductors that are arranged in a different layer with the second electrodes. As a result, the present touch panel device has simplified structure and manufacturing process. In addition, a uniform sensitivity is also obtained.

Many aspects of the present invention can be better understood with reference to the following embodiment, which are described in detail accompanying with the figures.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a generally used capacitive touch panel device.

FIG. 2 is a bottom view of a touch panel device in accordance with a first embodiment.

FIG. 3 is an exploded perspective view of the touch panel device of FIG. 2.

FIG. 4 is a partial cross sectional view of FIG. 2 along lien IV-IV.

FIG. 5 is an exploded perspective view of a touch panel device in accordance with a second embodiment.

FIG. 6 is a cross sectional view of the touch panel device of FIG. 5.

FIG. 7 is a cross sectional view of a touch panel device in accordance with a third embodiment.

FIG. 8 is a cross sectional view of a touch panel device in accordance with a fourth embodiment.

FIG. 9 is a cross sectional view of a touch panel device in accordance with a fifth embodiment.

FIG. 10 is a cross sectional view of a touch panel device in accordance with a sixth embodiment.

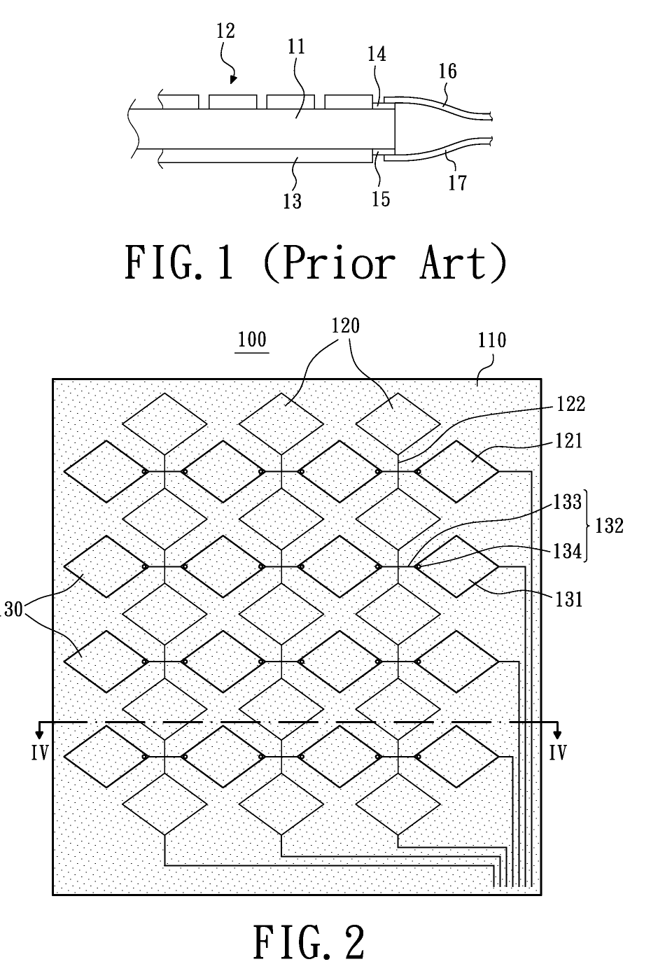

### DETAILED DESCRIPTION OF THE PREFERRED EMBODIMENTS

As shown in FIGS. 2 to 4, a touch panel device in accordance with a first embodiment is provided, which includes a substrate 110, a number of first electrode groups 120, a number of second electrode groups 130, an insulating layer 140, and insulating adhesive layer 160 and an anti-wearing layer 150. The substrate 110 includes a plain surface 111 for forming the first electrode groups 120 and the second electrode groups 130 thereon. The first electrode groups 120 and the second electrode groups 130 cooperatively define a capacitive sensing unit.

The first electrode groups 120 are formed on the plain surface 111 of the substrate 11. Each of the first electrode groups 120 includes a number of first electrodes 121 and a number of first leads 122. The first leads 122 lie in a same line and each electrically connects two adjacent first electrodes 121 (as shown in FIG. 2). The first electrodes 121 are spaced with/away from each other and are distributed on the plain surface of the substrate 111. Each of the first electrodes 121 is in a rhombus shape. However, it is to be understood that the shape of the first electrodes 121 may vary according to practical requirement rather than limited to rhombus. The first electrodes 121 in each first electrode group 120 are arranged as a linear array. Each first electrode group 120 constitute a linear array of first electrodes 121, thus, there are a number of linear arrays of first electrodes 121 formed on the plain surface 111. The linear arrays of the first electrodes 121 are parallel with each other. In other words, the first electrodes 121 of the first electrode groups 120 are arranged on the plain surface 111 of the substrate 110 in a matrix manner.

Each of the second electrode groups 130 includes a number of second electrodes 131 and a number of second bridge conductors 132 electrically connecting each two adjacent second electrodes 131. The second electrodes 131 are separately arranged on the plain surface 111 of the substrate 110 and are arrange in a staggered manner with the first electrodes 121 (in other words, the second electrodes 131 and the first electrodes 121 are interleavingly arranged). Each of the second electrodes 131 is in a rhombus shape. However, it is to be understood that the shape of the second electrodes 131 may change according to practical requirement rater that limited to rhombus. The second electrodes 131 in each second electrode group 130 are arranged as a linear array. Each second electrode group 130 constitute a linear array of the second electrodes 131, thus, there are a number of linear arrays of the second electrodes 131 formed on the plain surface 111. The linear arrays of the second electrodes 131 are parallel with each other. In other words, the second electrodes 131 of the second electrode groups 130 are arranged on the plain surface 111 of the substrate 110 in a matrix manner. The spaced bridge conductors 132 of each second electrode group 130 constitute a bridge lead along an arrangement direction of the second electrodes 131 in each second electrode group 130. Each of the bridge conductors 132 includes a first conducting portion 133 and a number of (e.g. two) second conducting portions 134 formed at two opposite ends of the first conducting portion 133. The first conducting portion 133 is a segment of electrically conductive lead and a length thereof corresponds to a distance between two adjacent second electrodes 131. Specifically, the length of the first conducting portion 133 can be slightly larger or less than the distance between two adjacent second electrodes 131. The second conducting portions 134 extend through the insulating layer 140 and electrically connect the first conducting portion 133 to two respective second electrodes 131.

The insulating layer 140 is formed on the plain surface 111 of the substrate 110. The insulating layer covers the first electrodes 121 of the first electrode groups 120, the first leads 122, and the second electrodes 131 of the second electrode groups 130. The insulating layer 140 includes a first surface 141 adjacent/adjoining to the substrate 110 and a second surface 143 away from the substrate 110. The first surface 1141 is opposite to the second surface 143. A number of through holes 142 extending through the first surface 141 and the second surface 143 are defined in the insulating layer 140. The second conducting portions 134 can be made by filling electrically conductive substance in the through holes 142.

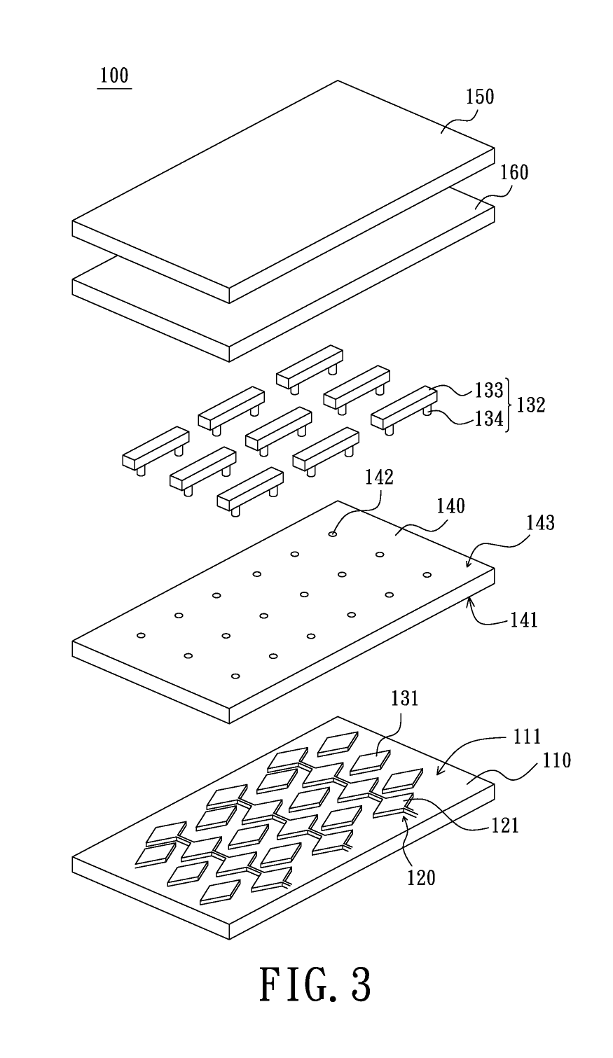

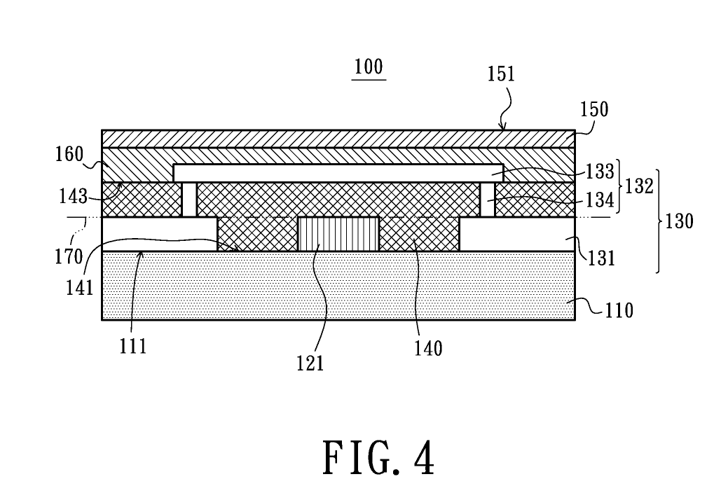

As shown in FIGS. 3 and 4, the first electrodes 121 in each of the first electrode groups 120 are separately arranged on the first surface 141 of the insulating layer 140, and the second electrodes 131 in each of the second electrode groups 130 are also separately arranged on the first surface 141 of the insulating layer 140. In addition, the first electrodes 121 and the second electrodes 131 are arranged in a staggered manner. The bridge leads of each second electrode group 130 (i.e. the bridge conductors 132) are formed on the second surface 143 (i.e. the surface opposite to the first surface 141) of the insulating layer 140. In other words, the first electrode groups 120 and the second electrode groups 130 lie in a same surface thereby cooperatively defining a sensing surface 170 (as shown by the dashed line in FIG. 4). The second electrodes 131 and the bridge conductors 132 are in different layers. As such, the second electrodes 131 arranged on the first surface 141 of the insulating layer 140 can be electrically connected by the bridge conductors 132 arranged on the second surface 143 of the insulating layer 140. The insulating layer 140 serves as an insulating medium of the first electrode groups 120 and the second electrode groups 130. In the present embodiment, the sensing surface 170 is between the substrate 110 and the bridge leads (i.e. the bridge conductors 132) of the second electrode groups 130.

The insulating adhesive layer 160 is formed on the insulating layer 140, and specifically, on the second surface 143 of the insulating layer 140. The insulating adhesive layer 160 covers the bridge conductors 132 of the second electrode groups 130.

The anti-wearing layer 150 is applied/attached on the insulating adhesive layer 160, and specifically, on a side of the insulating layer 160 that is away from the second surface 143 of the insulating layer 140. In addition, a film of anti-reflection material and/or protective material can be further formed on a surface of the anti-wearing layer 150. The anti-wearing layer 150 defines a contact surface 151 configured for contacting fingers or other electrically conductive objects.

In the present embodiment, the substrate 110 can be made of a transparent material selected from a group consisting of glass, poly methyl methacrylate (PMMA), polyvinylchloride (PVC), polypropylene (PP), polyethylene terephthalate (PET), polyarylene ether nitrile (PEN), polycarbonate (PC) and polystyrene (PS), or a non-transparent material. The material of the substrate 110 is selected according to practical requirement. The first electrode groups 120 and the second electrode groups 130 can be made of a transparent electrically conductive material such as indium tin oxide (Ito) or a non-transparent material. The insulating layer 140 can be made of an insulating transparent material such as silicon dioxide or an insulating non-transparent material.

In other words, the substrate 110, the first electrode groups 120, the second electrode groups 130 and the insulating layer 140 can all be made of transparent material. In another embodiment, the substrate 110, the first electrode groups 120, the second electrode groups 130 and the insulating layer 140 are all made of non-transparent material. In still another embodiment, the substrate 110, the first electrode groups 120, the second electrodes 130 of the second electrode groups 130 and the insulating layer 140 are made of transparent material, the bridge conductors 132 of the second electrode groups 130 are made of non-transparent material (e.g. metals such as silver). When a diameter of the bridge conductors 132 is less than a certain value, the do not influence transmission of light. Touch panel devices made from transparent material can be employed in devices including touch screen, for example, mobile phones, PDAs, global positioning systems (GPS) etc. For other applications, printed circuit boards or flexible printed circuit boards can be used to constitute the present touch panel device.

Compared with the prior art touch panel devices, the first electrode groups 120 and the second electrode groups 130 are arranged on a same side of the substrate 110, the insulating layer 140 serves as an electrically isolating medium of the first electrode groups 120 and the second electrode groups 130, the first electrodes 121 are electrically connected by the bridge conductors 132 that are arranged in a different layer with the second electrodes 131. As a result, the present touch panel device has simplified structure and manufacturing process. In addition, a uniform sensitivity is also obtained.

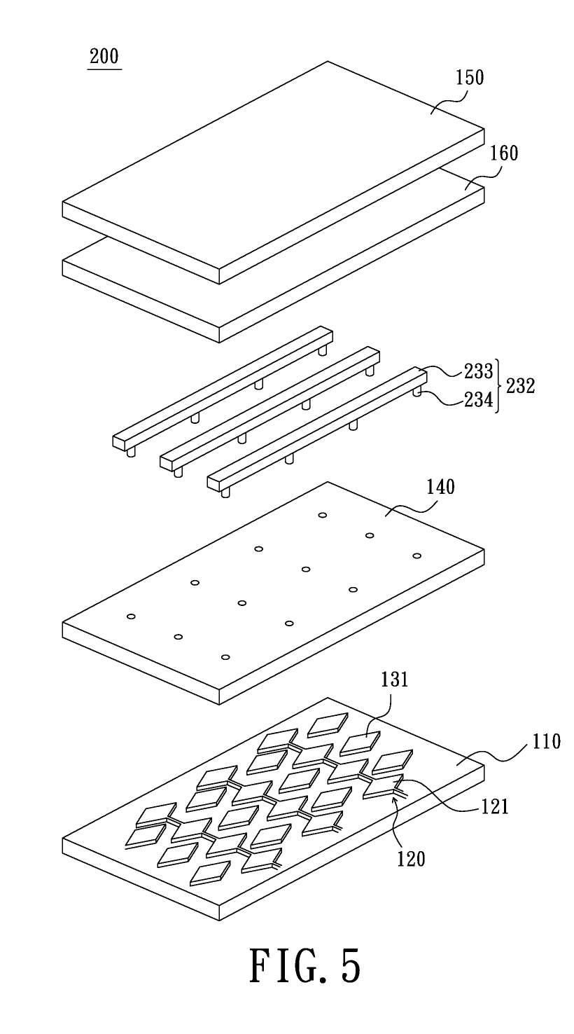

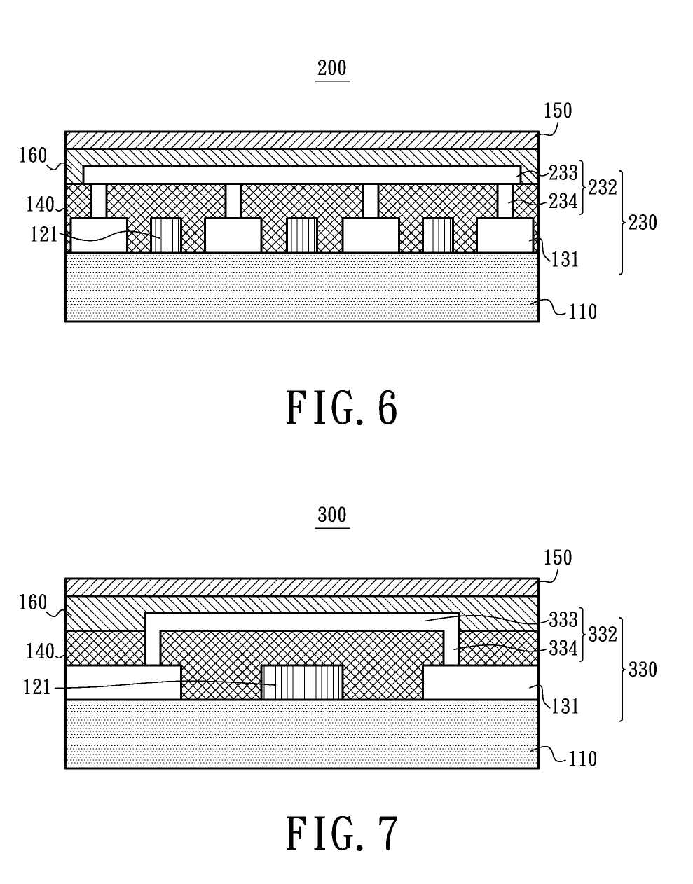

As shown in FIGS. 5 and 6, a touch panel device 200 in accordance with a second embodiment is similar to the touch panel device 100 of the first embodiment except that the structure of the second electrode groups 230. The touch panel device 200 includes a substrate 110, a number of first electrode groups 120, an insulating layer 140, an insulating adhesive layer 160 and an anti-wearing layer 150. Each of the first electrode groups 120 includes a number of first electrodes 121. Each of the second electrode groups 230 includes a number of second electrodes 131 and a bridge lead 232 configured for electrically connecting each two adjacent second electrodes 131. The bridge lead 232 includes a first conducting portion 233 and a number of second conducting portions 234 electrically connected to the first conducting portion 233. The first conducting portion 233 is an elongated/strip lead which corresponds to a number of second electrodes 131. The number of the second conducting portions 234 is equal to the number of second electrodes 131. That is, each of the second conducting portions 234 is corresponding to a respective second electrode 131. Each of the second electrodes 131 is electrically connected to the first conducting portion 233 via a corresponding second conducting portion 234. Thus, the second electrodes 131 are electrically connected to respective first conducting portion 233 via a corresponding first conducting portion 233, and the second electrodes 131 are electrically connected in series.

In the present embodiment, one end of each second conducting portion 234 is connected to the first conducting portion 233, and the other end is connected to a middle portion of the second electrode 131 (as shown in FIG. 6). It is to be understood that if an electrically connection between the second conducting portions 234 and the second electrodes 131 can be achieved, the other end of the second conducting portions 234 can also be connected to any portions of the second electrodes 131 rather than limited to the middle portion.

Compared with the prior art touch panel devices, the present touch panel device 200 includes all advantages of the touch panel device 100 as mentioned above. In addition, one first conducting portion 233 corresponds to a number of second electrodes 131 in the touch panel device 200; thus, a manufacturing process thereof can be further simplified.

Referring to FIG. 7, a touch panel device 300 in accordance with a third embodiment is similar to the touch panel device 100 of the first embodiment except that the structure of the second electrode groups 330. The touch panel device 300 includes a substrate 110, a number of first electrode groups 120, an insulating layer 140, an insulating adhesive layer 160 and an anti-wearing layer 150. Each of the first electrode groups 120 includes a number of first electrodes 121. Each of the second electrode groups includes a number of second electrodes 131 and a number of spaced/separated bridge conductors 332 configured for electrically connecting two adjacent second electrodes 131. The bridge conductors 332 are arrange along a linear arrangement direction of the second electrodes 131 thereby constituting a bridge lead. The bridge conductors 332 includes a first conducting portion 333 and a number of (e.g. two) second conducting portions 334 electrically connected to the first conducting portion 333. The first conducting portion 333 and the second conducting portion 334 are integrally formed. In the present embodiment, each of the bridge conductors 332 is a hoof/U shaped structure including a first conducting portion 333 and two second conducting portions 334 integrally formed with the first conducting portion 333.

Compared with the prior art touch panel device, the present touch panel device 300 includes all advantages of the touch panel device 100 as mentioned above. In addition, each of the bridge conductors 332 is a hoof/U shaped structure including a first conducting portion 333 and two second conducting portions 334 integrally formed with the first conducting portion 333, thus, a reliability of the bridge conductors 332 is improved. Furthermore, there is no need to form through holes in the insulating layer 140 and fill the through holes with conductive substance; a manufacturing process of the touch panel device 300 is further simplified.

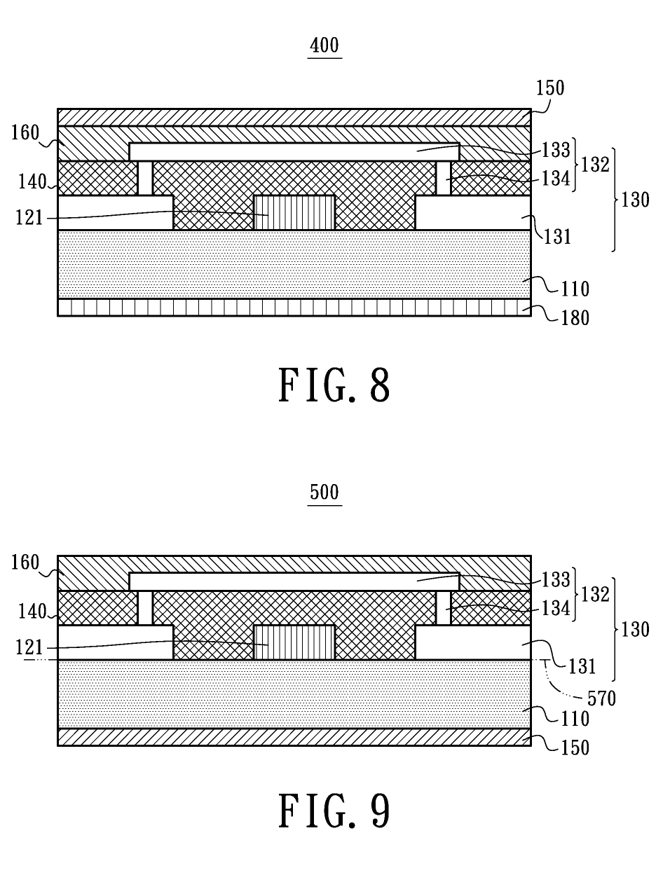

As shown in FIG. 8, a touch panel device 400 in accordance with a fourth embodiment is similar to the touch panel device 100 of the first embodiment except that further includes an electrically conductive layer 180. The touch panel device 400 includes a substrate 110, a number of first electrode groups 120, a number of second electrode groups 130, an insulating layer 140, an insulating adhesive layer 160 and an anti-wearing layer 150. Each of the first electrode groups 120 includes a number of first electrodes 121. Each of the second electrode groups 130 includes a number of second electrodes 131 and a number of second bridge conductors 132 electrically connecting each two adjacent second electrodes 131. Each of the bridge conductors 132 includes a first conducting portion 133 and a number of (e.g. two) second conducting portions 134 formed at two opposite ends of the first conducting portion 133. The electrically conductive layer 180 is arranged on a side of the substrate 110 that is away from the insulating layer 140. The electrically conductive layer 180 serves as an electro-magnetic shielding layer for preventing a light control module (LCM) disposed under the substrate 110 (i.e. disposed at the side that is away from the insulating layer 140) intervenes the first electrode groups 120 and the second electrode groups 130. Alternatively, the electrically conductive layer 180 can be made into a net-like structure so as to reduce a capacitance thereof.

Referring to FIG. 9, a touch panel device 500 in accordance with a fifth embodiment is similar to the touch panel device 100 of the first embodiment except that an arrangement of the anti-wearing layer 150. The touch panel device 500 includes a substrate 110, a number of first electrode groups 120 (as shown in FIG. 2), a number of second electrode groups 130, an insulating layer 140, an insulating adhesive layer 160 and an anti-wearing layer 150. Each of the first electrode groups 120 includes a number of first electrodes 121. Each of the second electrode groups 130 includes a number of second electrodes 131 and a number of second bridge conductors 132 electrically connecting each two adjacent second electrodes 131. Each of the bridge conductors 132 includes a first conducting portion 133 and a number of (e.g. two) second conducting portions 134 formed at two opposite ends of the first conducting portion 133. The anti-wearing layer 150 is arranged on a side of the substrate 110 that is away from the insulating layer 140, thus, a surface of the anti-wearing layer 150 that is away from the substrate 110 is a contact surface (not shown). Accordingly in the present embodiment, the substrate 110 is a transparent film 110; the LCM is disposed above the touch panel device 500 (i.e. outside of the insulating adhesive layer 160). In addition, the first electrode groups 120 and the second electrodes 131 of the second electrode groups 130 lie in a same surface thereby cooperatively defining a sensing surface 570 that is adjacent to the substrate 110 (as shown by the dashed line in FIG. 9). The sensing surface 570 is between the substrate 110 and the bridge conductors 132 of the second electrode groups 130.

Compared with the prior art touch panel device, the present touch panel device 500 includes all advantages of the touch panel device 100 as mentioned above. In addition, firstly, the first electrode groups 120 and the second electrode groups 130 are more closer to the contact surface, thus, a sensitivity of the touch panel device 500 is further improved; secondly, the insulating layer 140 increases a distance between the first electrode groups 120, the second electrode groups 130 and the LCM that is located outside of the insulating adhesive layer 160, thus an interference of the LCM to the touch panel device 500 is thereby reduced.

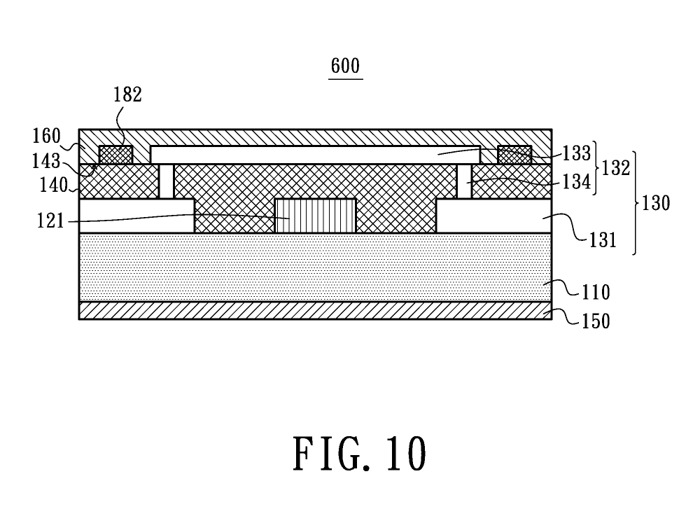

Referring to FIG. 10, a touch panel device 600 in accordance with a sixth embodiment is similar to the touch panel device 500 of the fifth embodiment except that further includes an electrically conductive layer 182. The touch panel device 600 includes a substrate 110, a number of first electrode groups 120, a number of second electrode groups 130, an insulating layer 140, an insulating adhesive layer 160 and an anti-wearing layer 150. Each of the first electrode groups 120 includes a number of first electrodes 121. Each of the second electrode groups 130 includes a number of second electrodes 131 and a number of second bridge conductors 132 electrically connecting each two adjacent second electrodes 131. Each of the bridge conductors 132 includes a first conducting portion 133 and a number of (e.g. two) second conducting portions 134 formed at two opposite ends of the first conducting portion 133. The electrically conductive layer 182 and the bridge conductors 132 are arranged on the second surface 143 of the insulating layer 140 and are electrically isolated from the insulating layer 160. The electrically conductive layer 182 serves as an electro-magnetic shielding layer for preventing a light control module (LCM) disposed above the substrate 110 (i.e. outside of the insulating adhesive layer 160) intervenes the first electrode groups 120 and the second electrode groups 130. Alternatively, the electrically conductive layer 182 can be made into a net-like structure so as to reduce a capacitance thereof.

It is to be understood that the bridge conductors of the present touch panel device are not limited to above illustrative embodiments. If any bridge conductors can satisfy conditions that the first electrode groups and the second electrodes in the second electrode groups lie in a same surface (or cooperatively defining a sensing surface), the bridge conductors and the sensing surface are in different layers (e.g. the bridge conductors are arranged on the second surface of the substrate and electrically isolated from the first electrode groups) the bridge conductors can be employed in the present touch panel device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch panel device, comprising:
a substrate;
an insulating layer formed on the substrate, the insulating layer comprising a first surface adjacent to the substrate and a second surface away from the substrate;
a plurality of first electrode groups formed on the first surface of the insulating layer, each of the first electrode groups comprising a plurality of first electrodes and a plurality of first leads, said plurality of first electrodes spacing with each other and being arranged on the first surface of the insulating layer, said plurality of first leads electrically connecting each two adjacent first electrodes; and
a plurality of second electrode groups, each of the second electrode groups comprising a plurality of second electrodes and a plurality of bridge conductors electrically connecting each two adjacent second electrodes, said plurality of second electrodes spacing with each other and being arranged on the first surface of the insulating layer, the first electrodes and the second electrodes being arranged in a staggered manner, the bridge conductors being formed on the second surface of the insulating layer.

2. The touch panel device as claimed in claim 1, wherein each of the bridge conductors comprising a first conducting portion and two second conducting portions formed on two opposite ends of the first conducting portion, the second conducting portions are respectively connected to two adjacent second electrodes.

3. The touch panel device as claimed in claim 2, wherein the first conducting portion and the two first conducting portions are integrally formed.

4. The touch panel device as claimed in claim 1, wherein the bridge conductor for each of the second electrode groups comprises a first conducting portion and a plurality of second conducting portions, each of the second conducting portions is electrically connected to a corresponding second electrode.

5. The touch panel device as claimed in claim 1, further comprising an insulating adhesive layer arranged on the second surface of the insulating layer, the insulating layer covering the bridge conductors of the second electrode groups.

6. The touch panel device as claimed in claim 5, further comprising an anti-wearing layer arranged on a side of the insulating layer that is away from the second surface of the insulating layer.

7. The touch panel device as claimed in claim 6, further comprising an electrically conductive layer arranged on a side of the substrate that is away from the insulating layer.

8. The touch panel device as claimed in claim 5, wherein the substrate is a transparent film.

9. The touch panel device as claimed in claim 8, further comprising an anti-wearing layer arranged on a side of the substrate that is away from the insulating layer.

10. The touch panel device as claimed in claim 9, further comprising an electrically conductive layer arranged on the second surface of the insulating layer, the electrically conductive layer being covered by the insulating adhesive layer and being electrically isolated from the bridge conductors of the second electrode groups.

11. A touch panel device, comprising:
a substrate including a plain surface;
an insulating layer formed on the substrate; and
a capacitive sensing unit comprising:
a plurality of first electrode groups covered by the insulating layer, each of the first electrode groups comprising a plurality of first electrode and a plurality of first lead configured for electrically connecting each two adjacent first electrodes, the first electrodes being spaced with each other and being formed on the plain surface of the substrate; and
a plurality of second electrode groups, each of the second electrode groups comprising a plurality of second electrodes and a bridge conductor configured for electrically connecting each two adjacent second electrodes, the second electrodes being spaced with each other and being formed on the plain surface of the substrate, the first electrodes and the second electrodes being arranged in a staggered manner, the second electrodes being covered by the insulating layer, the first electrodes and the second electrodes cooperatively defining a sensing surface, the bridge conductor is disposed on the insulating layer such that the sensing surface is arranged between the substrate and the bridge conductors.

12. The touch panel device as claimed in claim 11, wherein each of the bridge conductors comprising a first conducting portion and two second conducting portions formed on two opposite ends of the first conducting portion, the second conducting portions are respectively connected to two adjacent second electrodes.

13. The touch panel device as claimed in claim 12, wherein the first conducting portion and the two first conducting portions are integrally formed.

14. The touch panel device as claimed in claim 11, wherein the bridge conductor for each of the second electrode groups comprises a first conducting portion and a plurality of second conducting portions, each of the second conducting portions is electrically connected to a corresponding second electrode.

15. The touch panel device as claimed in claim 11, further comprising an insulating adhesive layer arranged on the second surface of the insulating layer, the insulating layer covering the bridge conductors of the second electrode groups.

16. The touch panel device as claimed in claim 15, further comprising an anti-wearing layer arranged on a side of the insulating layer that is away from the second surface of the insulating layer.

17. The touch panel device as claimed in claim 16, further comprising an electrically conductive layer arranged on a side of the substrate that is away from the insulating layer.

18. The touch panel device as claimed in claim 15, wherein the substrate is a transparent film.

19. The touch panel device as claimed in claim 18, further comprising an anti-wearing layer arranged on a side of the substrate that is away from the insulating layer.

20. The touch panel device as claimed in claim 19, further comprising a electrically conductive layer arranged on the second surface of the insulating layer, the electrically conductive layer being covered by the insulating adhesive layer and being electrically isolated from the bridge conductors of the second electrode groups.
